(19) United States
(12) Patent Application Publication
(10) Pub. No.: US 2014/0355994 A1
(43) Pub. Date: Dec. 4, 2014

(54) System and Method for the Sub-Octave Transmission of Multi-Octave Telecommunications Signals

(71) Applicant: Titan Photonics, Inc., Fremont, CA (US)

(72) Inventors: Chen-Kuo Sun, Escondido, CA (US); Charlie Chen, Santa Clara, CA (US); Eric Liu, Fremont, CA (US)

(21) Appl. No.: 13/906,212

(22) Filed: May 30, 2013

(51) Int. Cl. H04B 10/2575

(52) U.S. Cl. CPC H04B 10/2575
USPC 398/115

(57) ABSTRACT

A system and method are provided for transmitting multi-octave telecommunications signals, as sub-octave signals, on an optical fiber. Using different modems, digital signals are modulated onto respective radio frequency (RF) carriers. In detail, the resultant RF signals (fₙ) are all within a same lower frequency band. At least one fₙ is a multi-octave signal. A frequency changer switches each fₙ (possibly multi-octave) from the lower frequency band to an upper frequency band, where they avoid overlapping each other, and where they are each established as a sub-octave signal (f″ₙ). A combiner then groups the individual sub-octave signals (f″ₙ) into a single sub-octave signal (f″). Further, an electrical/optical converter creates an optical signal of wavelength (λ) for transmitting the combined sub-octave signal (f″) over the optical fiber.

### FIELD OF THE INVENTION

The present invention pertains to systems and methods for transmitting multi-octave telecommunications signals over a fiber optic. More particularly, the present invention pertains to systems and methods for transmitting sub-octave RF signals over a fiber optic. The present invention is particularly, but not exclusively, useful as a system and method for changing multi-octave telecommunications signals into sub-octave signals for subsequent transmission over a fiber optic.

### BACKGROUND OF THE INVENTION

It is known that second order distortions are particularly disruptive to the transmission of optical signals over a fiber optic cable. It is also known that the adverse effects of such second order distortions can be significantly suppressed when the transmissions involve only sub-octave signals. In this context, sub-octave transmissions for reducing second order distortions have been disclosed and claimed in U.S. patent application Ser. No. 12/980,008 by inventor Sun, filed on Dec. 28, 2010, for an invention entitled “Passive Optical Network with Sub-Octave Transmission,” and which is assigned to the same assignee as the present invention. Despite the benefits of sub-octave transmissions however, in some cases confining a signal to within a sub-octave band can undesirably limit the available bandwidth for the signal. Indeed, it will often happen in the lower frequency ranges that some telecommunications signals require a multi-octave bandwidth for an effective transmission of their content.

By way of example, it is generally accepted that Radio Frequency (RF) telecommunications signals can effectively carry approximately six bits of information per Hertz (6 b/Hz). Further, most commercial modems are capable of modulating approximately ten Giga-bits (10 Gb) of information onto an RF signal. Thus, modems which operate in a typical frequency band between zero and two Giga-Hertz (0→2 GHz), will require a bandwidth of around 1.6 GHz in order to generate a 10 Gb signal, carrying 6 b/Hz. This is more than half of the operational range of the typical modem and, when used, will result in a multi-octave signal in the lower frequency ranges.

As indicated above, in a fiber optic telecommunications system, a suppression of second order distortions can be realized when the transmitted signals have sub-octave bandwidths. In detail, a signal will be sub-octave when its bandwidth is between a low frequency F_{LO}, and a high frequency F_{Hi}, and the relationship between these frequencies satisfies the conditions that F_{LO}>½F_{Hi} and 2F_{LO}<F_{Hi}. As indicated above, however, there are instances when it may be necessary or desirable to transmit an originally multi-octave signal over an optical fiber.

Further to the example given above, although a 10 Gb signal with a required bandwidth (e.g. 1.6 GHz) may be a multi-octave signal in a low frequency range (e.g. 0→2 GHz), this same 10 Gb signal will become a sub-octave signal when it is switched up into a higher frequency range (e.g. 20-40 GHz). Moreover, even with this frequency shift, there is a substantial remaining capacity in the higher frequency range for combining the exemplary 10 Gb signal with other sub-octave signals. A consequence here is that many sub-octave signals can be combined in the higher frequency range for collective, simultaneous transmission on a fiber optic. With this increased signal capacity, there is a concomitant increase in speed of overall signal transmission on a particular system.

With the above in mind, it is an object of the present invention to provide an optical telecommunications system that preserves the content of a multi-octave RF signal when it is up-switched from a lower frequency band to a higher frequency band to become a sub-octave signal for transmission over a fiber optic. Another object of the present invention is to combine a plurality of sub-octave signals into a single sub-octave signal for transmission over a fiber optic. Yet another object of the present invention is to provide an optical telecommunications system which has an increased capacity for the transmission of sub-octave signals. Still another object of the present invention is to provide an optical telecommunications system that is easy to install, is simple to operate and is comparatively cost effective.

### SUMMARY OF THE INVENTION

In accordance with the present invention, a system and method are provided for transmitting multi-octave telecommunications signals, as sub-octave signals, on an optical fiber. As contemplated for the present invention, there will be a plurality of an n number of modems in the system, and each modem will generate a respective Radio Frequency RF signal (fₙ) within a lower frequency band (e.g. 0→2 GHz). For purposes of the present invention, each RF signal (fₙ) may have as much as 10 Gb content. Further, at least one modem in the system may create an RF signal (fₙ) which is a multi-octave signal in the lower frequency band.

A frequency changer is provided for the present invention to switch each RF signal (fₙ) up from the lower frequency band to an upper frequency band. Importantly, with this switch, each fₙ is established as a sub-octave signal (f″ₙ) in the upper frequency band. Importantly, the content of each RF signal being carried by a respective frequency (fₙ) will remain unchanged. The system also includes a combiner that will then group the sub-octave signals (f″ₙ) with their collective contents into a single sub-octave signal (f″). Stated differently, Σfₙ=Σf″ₙ=f″ wherein frequencies change from (f) to (f″) but the content remains constant. Further, after being switched to the upper frequency band, each of the RF signals (f″ₙ) avoids overlap with every other RF signal (f″ₙ).

An electrical/optical converter is also provided by the system for creating an optical signal of wavelength (λ) as a carrier for the sub-octave signal (f″). After conversion to the optical signal of wavelength (λ), the sub-octave signal (f″) is then transmitted over the optical fiber.

In an alternate embodiment of the present invention, an intermediate frequency band may be used. In this embodiment, the frequency changer will include a first frequency changer for switching each RF signal (fₙ) from the lower frequency band to an intermediate signal (f′ₙ) in the intermediate frequency band. Again, although the frequencies will change from (f) to (f′), the content of each RF signal remains constant. An intermediate combiner is then used to selectively group the intermediate signals (f′ₙ) into a plurality of groups of signals (f′_{g}). In this grouping, each f′_{g} may include a plurality of intermediate signals (f′ₙ). Accordingly, g will be an integer that is less than n. A second frequency changer is then used to switch each group of intermediate signals (f′_{g}) from the intermediate frequency band to the upper frequency band. At this point, the combiner is used to establish a combination of the intermediate sub-octave signals (f_{g}) as the single sub-octave signal (f″) in the upper frequency band.

For an exemplary system of the present invention, there may be around ten modules (e.g. n=10), and each RF signal (fₙ) can have as much as 10 Gb of content, and the content of each RF signal will be unique. Consequently, when the sub-octave signal (f″) is converted into the optical signal (λ), the transmitted optical signal may have as much as 100 Gb of content. In this exemplary system, the lower frequency band is within an approximate range of 0→2 GHz, and the upper frequency band is within an approximate range of 20 GHz→40 GHz. The intermediate frequency band is then within an approximate range of 5 GHz→10 GHz. Insofar as signal content is concerned, despite changes in carrier frequency (f→f′→f″), the signal content remains unchanged. On the other hand, within the embodiments of the present invention, the frequency progression is such that:

Σfₙ=Σf′ₙ=Σf′_{g}=Σf″ₙ=f″.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of the electronic components in a preferred embodiment of the present invention;

FIG. 2 is a schematic presentation of the electronic components in an alternate embodiment of the present invention; and

FIG. 3 is a table showing the relationships between signal bandwidths (multi-octave and sub-octave), RF frequency carrier bands, and signal information content for the preferred and alternate embodiments of the present invention.

### DESCRIPTION OF THE PREFERRED EMBODIMENTS

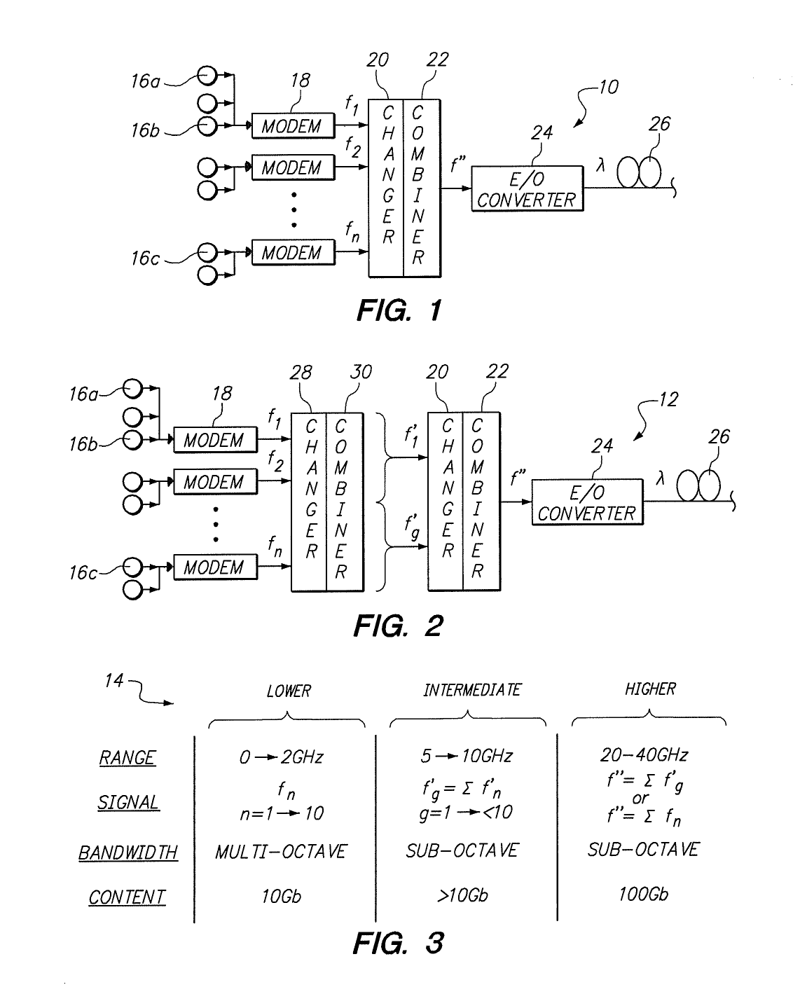

A system for changing the carrier frequency of a multi-octave signal, to provide for an optical transmission of the signal as a sub-octave signal, is shown in FIG. 1 and is generally designated 10. For an alternate embodiment of the present invention which incorporates a two-step frequency change, a comparable system is shown in FIG. 2 and is generally designated 12. A table showing the interrelationships of carrier frequencies for use in either of the systems 10 or 12 is shown in FIG. 3. In FIG. 3 this table is generally designated 14.

Referring initially to FIG. 1, it is seen that the system 10 includes a plurality of different signal originating units 16. Of these, the units 16a, 16b and 16c are exemplary. Within the system 10, each of the signal originating units 16 will operationally generate its own unique telecommunications signal and, in each instance, it is envisioned that the telecommunications signal will be a digital signal which includes binary bits of information.

As shown in FIG. 1, each of the signal generating units 16 is connected to a respective modem 18. The modems 18 are then used to convert the digital signal from the connected signal originating unit 16 into a Radio Frequency (RF) signal (f). For the system 10, there may be a plurality of different modems 18, and a plethora of different signal originating units 16 may use a same modem 18. Regardless the number of signal originating units 16, however, the system 10 will typically accommodate only an n number of different modems 18. More specifically, n will typically be ten or less. Accordingly, the system 10 is generally intended to transmit n different RF signals (fₙ).

It is an important aspect of the present invention that all of the different RF signals (fₙ) which are generated by their respective modem 18 will each initially be created in a same lower frequency range between zero and approximately two GHz (see Table 14 in FIG. 3). Further, it is important that any, or all, of the different RF signals (fₙ) may be a multi-octave signal in the lower frequency range.

With the above in mind, and referring back to FIG. 1, it will be seen that all of the RF signals (fₙ) are passed from their respective modem 18 to a frequency changer 20. At the frequency changer 20, the RF signals (fₙ) are up-switched to a higher frequency range where they are identified as f″ₙ. Importantly, with this switch in frequency range, the content of each signal f″ₙ remains unchanged, and is the same as the original content of the signal fₙ. By way of example, this higher frequency range may extend between twenty and forty GHz (see Table 14 in FIG. 3).

In the higher frequency range, the up-switched RF signals (f″ₙ) are then combined by the frequency combiner 22 into a single transmission RF signal (f″). At this point, an electrical/optical (E/O) converter 24 transfers the RF signal (f″) onto an optical carrier signal having a wavelength (λ). The optical signal (λ) is then transmitted over an optical fiber 26 to its destination address where, in a reverse process, each of the RF signals (fₙ) are reconstituted.

Before considering FIG. 2 and a description of the system 12, it is instructive to establish the notation that is used for the RF signals (fₙ) that are transmitted by either system 10 or system 12. In particular, these notations include reference to the frequency range being used. Thus, with cross reference to Table 14 in FIG. 3, it is to be understood that RF frequencies in the lower frequency range (0-2 GHz) are identified without any superscript (e.g. f and fₙ). On the other hand, RF frequencies in the intermediate frequency range (5-10 GHz) are identified with a prime mark (e.g. f′). Further, RF frequencies in the higher frequency range (20-40 GHz) are identified with a double prime (e.g. f″). In this context, the subscript n is used to designate a particular individual signal from a particular modem 18, and the subscript g is used to identify a grouping of these individual signals.

With the above in mind, and with specific reference to FIG. 2, it will be appreciated that, in many respects, the system 12 is equivalent to the system 10. System 12, however, incorporates the use of the intermediate frequency range (5-10 GHz). As shown, the system 12 incorporates a frequency changer 28 that up-switches each original signal (fₙ) from the lower frequency range (0-2 GHz) to a signal (f′ₙ) in the intermediate frequency range (5-10 GHz). A combiner 30 can then be used to group the signals (f′ₙ) into groups (f′_{g}) within the intermediate frequency range. The grouped signals (f′_{g}) are then transferred to the frequency changer 20 for further frequency switching and transmission over the optical fiber 26 as disclosed above with reference to the system 10. In all other aspects of the system 12, system 12 is essentially an equivalent of the system 10.

In summary, and in accordance with the notations defined above, it is to be appreciated that a progression of carrier frequencies for signals through the system 12 is mathematically defined as Σfₙ=Σf′ₙ=Σf′_{g}=Σf″ₙ=f″ wherein the lower, intermediate and higher frequency ranges are used. Similarly, but without using the intermediate frequency range, the progression of signals through the system 10 can be mathematically defined as Σfₙ=Σf″ₙ=f″. Recall, despite changes in the carrier frequencies (f→f′→f″), the signal content remains unchanged.

While the particular System and Method for the Sub-Octave Transmission of Multi-Octave Telecommunications Signals as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for transmitting multi-octave telecommunications signals as sub-octave signals on an optical fiber, which comprises:
a plurality of an n number of modems, wherein each modem modulates a respective digital signal onto a radio frequency (RF) carrier to create a respective plurality of RF signals (fₙ) within a substantially same lower frequency band, and wherein at least one RF signal (fₙ) is a multi-octave signal in the lower frequency band;
a frequency changer for switching each RF signal (fₙ) from the lower frequency band to an upper frequency band to establish each fₙ as a sub-octave signal (f″ₙ) in the upper frequency band, and wherein each RF signal (f″ₙ) avoids overlap with every other RF signal (f″ₙ) in the upper frequency band;
a combiner for grouping the sub-octave signals (f″ₙ) into a single sub-octave signal (f″); and
an electrical/optical converter for creating an optical signal of wavelength (λ) as a carrier for the sub-octave signal (f″) for transmission over the optical fiber.

2. A system as recited in claim 1 wherein the frequency changer comprises:
a first frequency changer for switching each RF signal (fₙ) from the lower frequency band to an intermediate frequency band to establish each RF signal (fₙ) as an intermediate signal (f′ₙ) in the intermediate frequency band;
an intermediate combiner for selectively grouping the sub-octave signals (f′ₙ) into a plurality of groups of sub-octave signals (f′_{g}); and
a second frequency changer for switching each group of intermediate signals (f′_{g}) from the intermediate frequency band to the upper frequency band to establish a combination of the intermediate sub-octave signals (f′_{g}) as the sub-octave signal (f″).

3. A system as recited in claim 2 wherein:
Σfₙ=Σf′ₙ=Σf′_{g}=Σf″ₙ=f″.

4. A system as recited in claim 1 wherein each RF signal (fₙ) may have as much as 10 Gb of content.

5. A system as recited in claim 4 wherein the sub-octave signal (f″), when carried on the optical signal (λ), may have as much as 100 Gb of content.

6. A system as recited in claim 5 wherein n=10.

7. A system as recited in claim 2 wherein the lower frequency band is within an approximate range of 0→2 GHz, and wherein bandwidths are established for multi-octave RF signals (fₙ) between frequencies F₁ and F₂, when F₁<½F₂ and F₂>2F₁.

8. A system as recited in claim 7 wherein the intermediate frequency band is within an approximate range of 5 GHz→10 GHz and the upper frequency band is within an approximate range of 20 GHz→40 GHz.

9. A system for transmitting multi-octave telecommunications signals as sub-octave signals on an optical fiber, which comprises:
at least one modem for creating a multi-octave Radio Frequency (RF) signal (f), wherein f has a bandwidth between the frequencies F₁ and F₂, with F₁<½F₂ and F₂>2F₁, and wherein f is in a lower frequency band;
a frequency changer for switching f from the lower frequency band to an upper frequency band to establish f as a sub-octave RF signal (f″) in the upper frequency band in a bandwidth between the frequencies F_{Lo} and F_{Hi} with F_{LO}>½F_{Hi} and F_{Hi}<2F_{LO}; and
an electrical/optical converter for creating an optical signal of wavelength (λ) as a carrier for the transmission of f″ over the optical fiber.

10. A system as recited in claim 9 further comprising:
a plurality of an n number of modems, wherein each modem modulates a respective digital signal onto a radio frequency (RF) carrier to create a respective plurality of RF signals (fₙ) within a substantially same lower frequency band, for a subsequent switching of the signals (fₙ) by the frequency changer to a sub-octave signal (f″ₙ), wherein each f″ₙ avoids overlap with every other f″ₙ in the upper frequency band; and
a combiner for grouping the sub-octave signals (f″ₙ) into the single sub-octave signal (f″).

11. A system as recited in claim 10 wherein the frequency changer comprises:
a first frequency changer for switching each RF signal (fₙ) from the lower frequency band to an intermediate frequency band to establish each fₙ as an intermediate signal (f′ₙ) in the intermediate frequency band;
an intermediate combiner for selectively grouping the sub-octave signals (f′ₙ) into a plurality of groups of signals (f′_{g}); and
a second frequency changer for switching each group of intermediate signals (f′_{g}) from the intermediate frequency band to the upper frequency band to establish a combination of the intermediate signals (f′_{g}) as the sub-octave signal (f″), while avoiding any overlap of the signals (f′_{g}) in f″.

12. A system as recited in claim 11 wherein:
Σfₙ=Σf′ₙ=Σf′_{g}=Σfₙ=f″.

13. A system as recited in claim 11 wherein each RF signal (fₙ) may have as much as 10 Gb of content.

14. A system as recited in claim 11 wherein the sub-octave signal (f″), when carried on the optical signal (λ), may have as much as 100 Gb of content.

15. A system as recited in claim 11 wherein the lower frequency band is within an approximate range of 0→2 GHz, wherein the intermediate frequency band is within an approximate range of 5 GHz→10 GHz and the upper frequency band is within an approximate range of 20 GHz→40 GHz.

16. A method for transmitting multi-octave telecommunications signals as sub-octave signals on an optical fiber, which comprises the steps of:
providing a plurality of an n number of modems, wherein each modem modulates a respective digital signal onto a radio frequency (RF) carrier to create a respective plurality of RF signals (fₙ) within a lower frequency band, and wherein at least one RF signal (fₙ) is a multi-octave signal in the lower frequency band;
switching each RF signal (fₙ) from the lower frequency band to an upper frequency band to establish each of the RF signals (fₙ) as a sub-octave signal (f″ₙ) in the upper frequency band, wherein each RF signal (f″ₙ) avoids overlap with every other RF signal (f″ₙ) in the upper frequency band;
grouping the sub-octave signals (f″ₙ) into a single sub-octave signal (f″); and
creating an optical signal of wavelength (λ) as a carrier for the sub-octave signal (f′) for transmission over the optical fiber.

17. A method as recited in claim 16 further comprising the steps of:
first switching each RF signal (fₙ) from the lower frequency band to an intermediate frequency band to establish each of the RF signals (fₙ) as an intermediate signal (f′ₙ) in the intermediate frequency band;
selectively grouping the sub-octave signals (f′ₙ) in the intermediate frequency band into a plurality of groups of signals (f′_{g}); and
second switching each group of intermediate signals (f′_{g}) from the intermediate frequency band to the upper frequency band to collectively establish a combination of the intermediate signals (f′_{g}) as the sub-octave signal (f″).

18. A method as recited in claim 17 wherein:
Σfₙ=Σf′ₙ=Σf′_{g}=Σf″ₙ=f″.

19. A method as recited in claim 17 wherein each RF signal (fₙ) may have as much as 10 Gb of content and the sub-octave signal (f″) in the upper frequency range may have as much as 100 Gb of content, when carried on the optical signal (λ).

20. A method as recited in claim 17 wherein the lower frequency band is within an approximate range of 0→2 GHz, wherein the intermediate frequency band is within an approximate range of 5 GHz→10 GHz, and the upper frequency band is within an approximate range of 20 GHz→40 GHz.
